(19) United States
(12) Patent Application Publication
(10) Pub. No.: US 2006/0038402 A1
(43) Pub. Date: Feb. 23, 2006

(54) Efficient fluid coupling and method

(76) Inventors: Wesley Miles Norman, Landenberg, PA (US); Bruce Douglas Quimby, Lincoln University, PA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/924,399

(22) Filed: Aug. 23, 2004

(51) Int. Cl. F16L 25/00

(52) U.S. Cl. 285/384

(57) ABSTRACT

A fluid coupling comprises a fitting body feature, a compression nut configured to fit within the fitting body feature, and a ferrule configured to seal a tube against the fitting body feature, whereby an end of the tube extends beyond the ferrule into a volume formed by the fitting body feature and the ferrule so that the volume is swept by a flow through the tube.

### BACKGROUND

Many chemical analysis applications use one or more sample tubes to collect, concentrate, and transfer a representative sample of a material to an analysis device. The sample tube, sometimes referred to as a capillary tube, or a capillary column, is connected to an analysis device, such as, for example, a gas or liquid chromatograph using a fluid tight seal. In other applications, an analysis column of a chromatograph comprises one or more tubes that are connected to a fluidic path. When coupling a tube to a fluidic path, it is desirable for all of the area of the tube to be swept when the material in the tube is transferred to the fluidic path. In most applications, the tube must be mechanically and fluidically coupled to another tube or a fluid path.

When coupling a tube to another tube or to a fluidic path using a mechanical fitting, care should be exercised so that the coupling allows a secure connection, while eliminating any spaces between the tubes, or between the tube and the fluidic path, that could collect and trap some of the sample material that is passing through the connection. Conventional fittings frequently allow what is referred to as a “dead volume” to form where the tube meets the fluidic path. The term “dead volume” refers to an area at the junction of the tube and the fluidic path that remains unswept as the flow of sample material passes through the tube and into the fluidic path. Unfortunately, the dead volume in these conventional fittings results in incomplete transfer of material out of the tube and also results in places at the tube-fluidic path junction where sample material may collect and provide false analysis results. So called “zero-dead-volume” couplings attempt to minimize the amount of unswept area at the coupling. Unfortunately, “zero-dead-volume” fittings still allow the formation of parasitic voids and unswept volumes in the vicinity of the tube where the tube and the sealing feature of the fitting meet. Further, zero-dead-volume fittings are difficult to manufacture and, in the case of a chromatograph, allow exposure of the material coating the tube that absorbs and retains components of the chromatographic sample flow.

Therefore, it would be desirable to provide an improved fluidic coupling from a tube to a fluidic path.

### SUMMARY OF INVENTION

According to one embodiment, a fluid coupling comprises a fitting body feature, a compression nut configured to fit within the fitting body feature, and a ferrule configured to seal a tube against the fitting body feature, whereby an end of the tube extends beyond the ferrule into a volume formed by the fitting body feature and the ferrule so that the volume is swept by a flow through the tube.

Other embodiments and methods of the invention will be discussed with reference to the figures and to the detailed description of the preferred embodiments.

### BRIEF DESCRIPTION OF THE FIGURES

The invention will be described by way of example, in the description of exemplary embodiments, with particular reference to the accompanying figures.

FIG. 1 is a schematic diagram illustrating a simplified chromatograph in which a fluid coupling constructed in accordance with an embodiment of the invention may reside.

FIG. 2 is a schematic diagram illustrating an embodiment of a fluid coupling of FIG. 1.

FIG. 3 is a schematic diagram illustrating a cross section view of a portion of the fluid coupling of FIG. 2.

### DETAILED DESCRIPTION

While described below for use in a gas chromatograph, the fluid coupling to be described below can be used in any analysis application where it is desirable to couple a small diameter tube to a fluidic path.

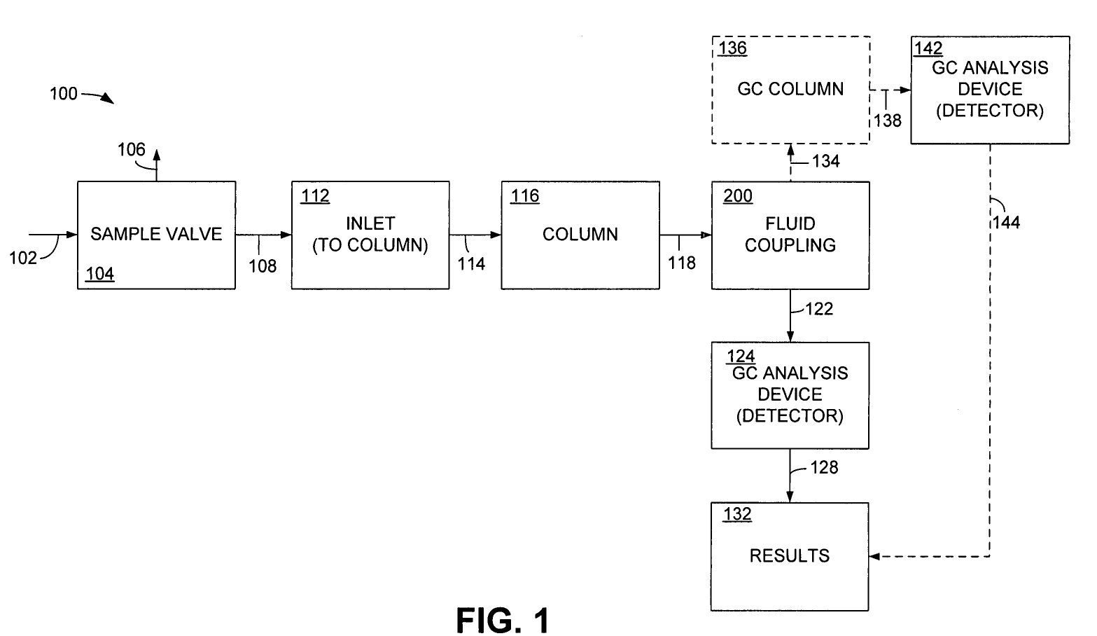

FIG. 1 is a block diagram illustrating a simplified gas chromatograph 100, which is one possible device in which the fluid coupling of the invention may be implemented. The fluid coupling of the invention may also be used in any gas phase sampling device or in any analytical device, and may also be useful for liquid phase couplings. The fluid coupling can be used to couple metal, fused silica, and any other small bore, small outer diameter tubing to a fluid coupling.

The gas chromatograph 100 includes a sample valve 104 which receives a sample of material to be analyzed via connection 102 and provides the sample via connection 108 to, for example, the inlet 112 of a gas chromatograph. For example, the inlet 112 might be the inlet to a chromatographic column. The sample valve 104 also includes a sample vent 106 as known in the art. The sample is transferred from the inlet 112 to a chromatographic column 116. The output of the chromatographic column 116 is coupled via connection 118 to the fluid coupling 200. In accordance with an embodiment of the invention, the fluid coupling 200 can be used to couple a capillary tube, such as a chromatographic column, or any other tubing to another fluid coupling within the device. In this example, the fluid coupling 200 is used to couple the chromatographic column 116 to a detector 124 in the gas chromatograph.

The connection 122, may include, for example, manifolds, tubing, or any other fluid connection to which the output of the column 116 can be coupled. In some implementations, the fluid coupling 200 may be used as a coupling to another chromatographic column 136, which is coupled to another detector 142. In such an implementation, the fluid coupling is referred to as a “Deans” switch. The output of the detector 124, via connection 128 is a signal representing the result 132 of the analysis.

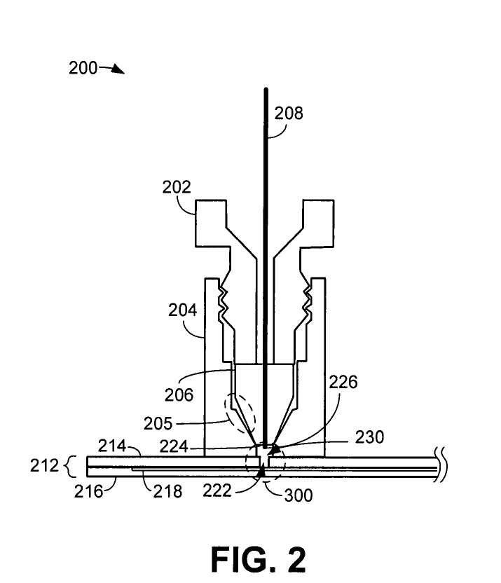

FIG. 2 is a schematic diagram illustrating an embodiment of the fluid coupling 200 of FIG. 1. The fluid coupling 200 includes a fitting body 204 having a feature 205. A nut 202 is threaded or otherwise secured into the fitting body 204. The nut 202 abuts and, when tightened, compresses a ferrule 206 into the inner surfaces of the fitting body 204 and the fitting body feature 205. A tube 208 passes through the ferrule 206 and can be secured to the inside of the ferrule 206 by, for example, a swage fit, or other connection. The ferrule 206 can be, for example, a metallic component that will not absorb any sample material flowing through the tube 208. The ferrule 206 may be fabricated from a metal such as silver, aluminum, gold, etc. or from a polymeric material, such as polyimide, polyimide/graphite, Teflon, etc. The ferrule 206, when compressed by tightening the nut 202, exerts a downward force and seals a tube 208 against the interior surfaces of the fitting body 204 and the fitting body feature 205. The fluid coupling 200 is designed to mate a tube 208, such as a chromatographic capillary column, to a low-volume diffusion bonded manifold or another fluidic component where it is desirable to mate a tube to a fluidic path while minimizing chromatographic band spreading and the effect of surface activity. The fluid coupling 200 is characterized by a minimal void volume, also referred to as the swept volume 230, leading to a conical sealing surface defined by the interior walls of the fitting body 204 and the fitting body feature 205 into which the ferrule 206 is received.

The protrusion of the tube 208 into the swept volume 230 ensures that any material flowing through the tube 208 will not become trapped in the swept volume 230. Any material in the tube 208 will flow through the hole 222 in the manifold 212. The manifold 212 can be, for example, a diffusion bonded plate manifold, or any other element that defines a fluidic path or feature.

The manifold 212 comprises a first portion 214 and a plate 216. The plate 216 includes a channel 218 into which the material flowing through the tube 208, and through the swept volume 230 and hole 222 is directed. Reference numeral 300 indicates the swept volume 230 and associated elements that define the swept volume 230, and will be described in greater detail below. As shown in FIG. 2, the tube 208 extends slightly past the end 224 of the ferrule 206. The tube 208 is fitted through the ferrule 206 with a slightly excessive length and the ferrule 206 is swaged onto the tube 208. Following this operation, the tube is scored and cut, thus leaving a slightly exposed portion 226 extending beyond the end 224 of the ferrule 206. The swaged tube 208, ferrule 206 and nut 202 are inserted into the fitting body 204 and the nut 202 is tightened to develop a semi-permanent seal that may be reused several times.

The swept volume 230 is coupled to a restricted section of the flow path, indicated as the channel 218. In one embodiment, the centerline of the tube 208 might be off-center from the hole 222, assuring adequate swirling in the swept volume 230. In another embodiment, the centerline of the tube 208 can be centered with respect to the hole 222. The fluid coupling 200 is generally useful for a variety of analysis technologies. For example, the fluid coupling is useful in “chromatographic” type flow, in which the time-sequence of elutants is not disturbed by the means of material conveyance.

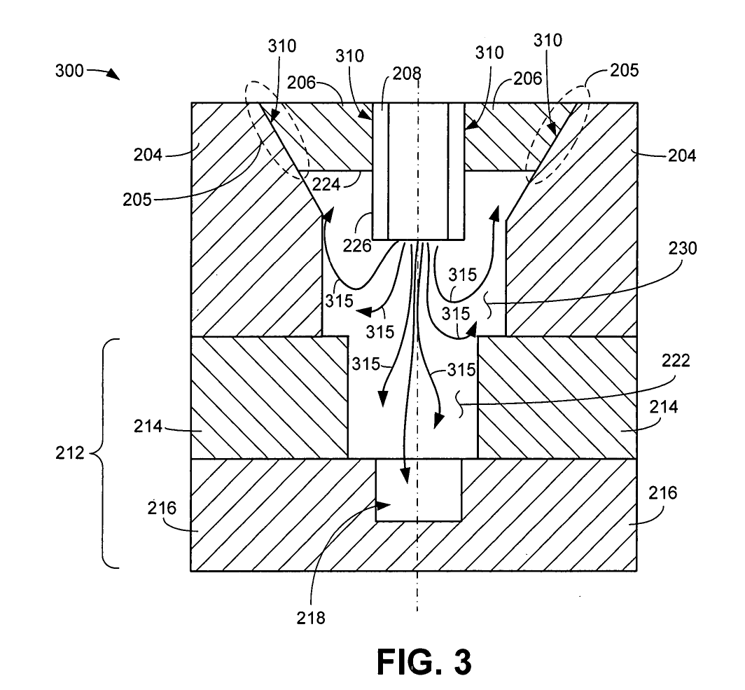

FIG. 3 is a schematic diagram 300 illustrating the swept volume 230 of FIG. 2. As shown in FIG. 3, a portion 226 of the tube 208 extends past the end 224 of the ferrule 206. The swept volume 230, and the hole 222 together with the exposed portion 226 of the tube 208 ensure that a swirling effect occurs in the swept volume 230 when sample material flows through the tube 208, through the swept volume 230, through the hole 222 and into the channel 218 in the manifold 212.

The surfaces indicated at 310 provide a sealing surface between the ferrule 206 and the tube 208, and between the ferrule 206 and the fitting body 204. In one embodiment, the fluid coupling 200 is useful for tubes having an inner diameter of 100 micrometers (μm) or less, and preferably an inner diameter of 0.25 through 0.53 millimeters (mm). The fluid coupling 200 is also useful for tubes having an outer diameter of 0.3 through 0.8 mm. The sealing surface 310 between the ferrule 206 and the fitting body 204 and between the ferrule 206 and the outer diameter of the tube 208 is very near to, and includes the end of the ferrule 206, limiting exposed areas where sample material may be trapped in the swept volume 230 to desorb slowly. The exposed portion 226 of the tube 208 allows the flow of the sample material through the tube 208 to create a sweeping effect in the swept volume 230 due to swirling as material passes through the tube 208 and enters the swept volume 230. The swirling effect is indicated at 315.

Further, because the portion 226 of the tube 208 that is exposed to the swept volume 230 is minimal, and particularly in a chromatograph application, tailing due to adsorption of sample material by the column coating is minimized. Because the exposed portion 226 of the tube 208 is minimal, it is easily deactivated, thereby forming an inert surface and minimizing any negative effects caused by the exposed portion 226 of the tube 208. Further still, the fluid coupling 200 described above reduces the necessity of precisely forming the end of the tube 208. In accordance with an embodiment of the fluid coupling 200, the end cut of the tube 206 need not be precisely formed. The fluid coupling will function if the end 226 of the tube 208 is imprecisely cut. Indeed, the fluid coupling will function even if the end 226 exhibits a ragged, non-square cut.

The foregoing detailed description has been given for understanding exemplary implementations of the invention and no unnecessary limitations should be understood therefrom as modifications will be obvious to those skilled in the art without departing from the scope of the appended claims and their equivalents. Other devices may use the efficient fluid coupling described herein.

We claim:

1. A fluid coupling, comprising:
a fitting body feature;
a compression nut configured to fit within the fitting body feature; and
a ferrule configured to seal a tube against the fitting body feature, whereby an end of the tube extends beyond the ferrule into a volume formed by the fitting body feature and the ferrule so that the volume is swept by a flow through the tube.

2. The fluid coupling of claim 1, further comprising a manifold portion through which material in the swept volume passes from the tube.

3. The fluid coupling of claim 1, wherein a center of the tube is located offset from a center of the volume.

4. The fluid coupling of claim 1, wherein a center of the tube is centered with a center of the volume.

5. The fluid coupling of claim 1, wherein the ferrule is configured to accept a tube having an outer diameter of 0.3 through 0.8 millimeters (mm).

6. The fluid coupling of claim 1, wherein the ferrule is configured to accept a tube having an inner diameter of 0.25 through 0.53 millimeters (mm).

7. The fluid coupling of claim 4, wherein the tube is part of a chromatographic column.

8. The fluid coupling of claim 6, wherein the manifold further comprises a channel into which any material in the swept volume passes.

9. A fluid coupling, comprising:
a fitting body;
a compression nut configured to fit within the fitting body;
a tube coupled to a ferrule; and
wherein the ferrule is configured to seal the tube against the fitting body, whereby an end of the tube extends beyond the ferrule into a volume formed by the fitting body, the ferrule, and a manifold so that the volume is swept by a flow through the tube.

10. The fluid coupling of claim 9, wherein a center of the tube is located offset from a center of the volume.

11. The fluid coupling of claim 9, wherein a center of the tube is centered with a center of the volume.

12. The fluid coupling of claim 9, wherein the ferrule is configured to accept a tube having an outer diameter of 0.3 through 0.8 millimeters (mm).

13. The fluid coupling of claim 9, wherein the ferrule is configured to accept a tube having an inner diameter of 0.25 through 0.53 millimeters (mm).

14. The fluid coupling of claim 12, wherein the tube is part of a chromatographic column.

15. The fluid coupling of claim 13, wherein the manifold further comprises a channel into which any material in the swept volume passes.

16. A method for forming a fluid coupling, comprising:
forming a fluid tight coupling by coupling a tube to a ferrule, a portion of the tube extending beyond the ferrule;
inserting the ferrule into a fitting body;
inserting a nut into the fitting body in contact with the ferrule;
tightening the nut to provide a fluid-tight seal between the ferrule and the tube and between the ferrule and the fitting body.

17. The method of claim 16, wherein the portion of the tube extending beyond the ferrule causes a swirling effect when fluid exits the tube and enters a volume formed by the ferrule and the fitting body.

18. The method of claim 17, further comprising offsetting the tube from a center of the volume.

19. The method of claim 17, further comprising centering the tube with a center of the volume.
